(19) United States
(12) Patent Application Publication
(10) Pub. No.: US 2014/0247689 A1
(43) Pub. Date: Sep. 4, 2014

(54) Method and Apparatus to Produce Hydrogen-Rich Materials

(71) Applicant: Centaqua Inc., East Brunswick, NJ (US)

(72) Inventors: Meiling Wang, East Brunswick, NJ (US); Lili Huang, East Brunswick, NJ (US)

(73) Assignee: Centaqua Inc., East Brunswick, NJ (US)

(21) Appl. No.: 14/162,391

(22) Filed: Jan. 23, 2014

Related U.S. Application Data
(60) Provisional application No. 61/771,617, filed on Mar. 1, 2013.

(51) Int. Cl. B01F 3/04; A23L 2/54

(52) U.S. Cl. CPC B01F 3/04; A23L 2/54; B01F 2003/04914
USPC 366/348; 261/105; 206/6

(57) ABSTRACT

Hydrogen molecule (H₂) has been indicated as a novel anti-oxidant reagent specifically targeting OH free radicals. This invention discloses the methods and apparatus that can be used to increase the hydrogen concentration in water, in beverages, and in other hydrogen absorbing materials through a sealed hydrogen gas producing chamber made of materials that have good hydrogen permeability and can withhold gas pressure. The disclosed method and apparatus can increase the hydrogen concentration quickly without leaking other chemical by-products of the gas producing system into the treated materials.

The present invention claims priority under 35 U.S.C. §119 to U.S. Provisional Patent Application No. 61/771,617, titled “Method and Apparatus to Produce Hydrogen-Rich Materials”, filed Mar. 1, 2013, which is incorporated herein by reference in its entirety.

### TECHNICAL FIELD

Hydrogen molecule (H₂) has been indicated as a novel anti-oxidant reagent specifically targeting OH free radicals. This invention discloses the methods and apparatus that can be used to increase the hydrogen concentration in water, in beverages, and in other hydrogen absorbing materials through a sealed hydrogen gas producing chamber made of materials that have good hydrogen permeability and can withhold gas pressure. The disclosed method and apparatus can increase the hydrogen concentration quickly without leaking other chemical by-products of the gas producing system into the treated materials.

### BACKGROUND OF THE INVENTION

Hydrogen molecule (H₂) has been indicated as a novel anti-oxidant reagent specifically targeting OH free radicals. It shows many unique advantages over other anti-oxidant reagent in preventive and therapeutic applications. Due to its specificity targeting OH free radicals, it was proposed that the adverse effect of hydrogen as an anti-oxidant reagent is very small. Compared to other anti-oxidant reagent, hydrogen can rapidly diffuse in human body. It can reach mitochondria and nucleus effectively to protect the organelle, and it can also pass through blood-brain barrier while many other anti-oxidant reagents cannot. Daily consumption of hydrogen-rich water prevented atherosclerosis, alleviated nephrotoxicity, improved brain injury and prevented chronic nephropathy. It was reported that the consuming hydrogen rich water improves lipid and glucose metabolism in patients with type 2 diabetes. Since hydrogen can pass through blood brain barrier, it can reduce the oxidative stress in brain and prevents the stress-induced cognitive decline. Hydrogen also has preventive and therapeutic effect for Parkinson's disease. Previous animal studies have demonstrated protective effect of hydrogen gas for ischemia reperfusion injury in cerebral, spinal cord, cardiac, and hepatic ischemia reperfusion injury models, and it showed protective effect on organ transplantation. Hydrogen can prevent the adverse effects by an anti-tumor drug like Cisplatin, and it also has anti-allergic effect. The therapeutic and preventive application of hydrogen molecule is expanding.

Oral intake of liquid containing hydrogen represents an easy method of delivery of hydrogen molecule to human. Hydrogen-rich water can be produced by adding the hydrogen gas into the water. Hydrogen gas can be generated by many methods including:

2H₂0=2H₂+O₂ Water electrolysis

Mg+2HCl=MgCl₂+H₂ Metal grain+Acid (e.g. Magnesium and Hydrochloride)

2Mg+2H₂O=2Mg(OH)₂+H₂ Metal grain (e.g. Magnesium)+Water

The water electrolysis method of adding hydrogen gas into water is marketed as “water ionizer”. Through electrolysis, hydrogen is produced at the anode and the metal ions (sodium, magnesium, and calcium ions, etc.) are enriched at the anode side liquid, and the water released from the anode side is so called “alkaline water”. The oxygen is produced at the cathode side and the liquid is becoming acidic at the cathode side.

One example of using magnesium and water reaction to produce hydrogen is also commonly referred “magnesium stick” method. To make hydrogen-rich water, magnesium grains are stored in a case made of porous ceramics (1) or porous plastic (2) or porous metal. These cases are water permeable through the holes on the case. The stick is immersed inside a container filled with water. Hydrogen gas is generated through reaction between magnesium and water. In another patent application, other components are also added besides the magnesium, such as gypsum (Calcium sulfate) and magnesium sulfate (3).

Some common issues associated with these existing methods:

The issue of chemical by-products and their adverse effects: There are many by-products from above chemical reactions (water electrolysis or magnesium stick method). For example in the water electrolysis, the calcium or magnesium ions are enriched in the released alkaline water. In the magnesium stick reaction, magnesium chloride or magnesium hydroxide is produced. Magnesium chloride and magnesium hydroxide are well known laxative. The adverse effect of loose stool and diarrhea is well documented in clinical application of hydrogen-rich water using magnesium stick (4). Long-term use of the laxatives could lead to chronic diarrhea. The hardness of the water (derived from the enriched calcium or magnesium ion) or total dissolved salt (TDS) is increased by using above methods. Although the adverse effect associated with water hardness is not conclusive, it is generally recommended to drink softer water if accessible. A robust method is needed to releasing only hydrogen without adding all the by-products of chemical reaction or water electrolysis.

The issue of slow speed of adding hydrogen: The speed of hydrogen gas generation between magnesium and water is very slow as in the “magnesium stick” method, which is multiple magnitudes slower compared to many acidic-metal based hydrogen gas production reactions. Typically, user needs to wait 24 hours to get some hydrogen into the drinking water using “magnesium stick” method (4). In addition, reaction between magnesium and water will generate magnesium hydroxide, which is insoluble in water. Magnesium hydroxide will eventually cover the surface of the magnesium, and the reaction will stop when the magnesium surface is covered completely. A fast and portable method is also needed on the market to add hydrogen into the drinking water quickly and conveniently.

The issue of high hydrogen gas pressure: To increase the speed of hydrogen gas production, it will naturally result in build-up of hydrogen gas pressure in a reaction chamber. This demands the reaction chamber can tolerate high gas pressure. The porous “magnesium stick” will not hold any gas pressure. Reverse osmosis membranes have been proposed in two patent applications (5,6) for selectively releasing hydrogen gas into water. The reverse osmosis membranes in its various formats cannot tolerate the acidic reaction environment, high gas pressure build-up in the reaction chamber, high temperature from the various beverages. It is also physically difficult to engineer a thin low cutoff reverse osmosis membrane as a pressure-bearing durable reaction chamber. The breakdown of the thin membrane will result in the release of the un-desired chemicals (and metal pieces) into the drinking water as a major health hazard. A reliable chamber that can tolerate high gas pressure is also needed.

The issue of beverage diversity: Water electrolysis and magnesium stick methods are targeting to add hydrogen into pure drinking water, and they cannot be used for adding hydrogen gas directly to other beverages like soda, energy drink, coffee, tea, milk, and juice, etc. Water electrolysis or magnesium stick treatment cannot be applied directly to these common beverages due to the complex and even toxic chemical by-products derived from electrolysis reactions of these beverages and those by-products derived from the reactions with metal magnesium.

The issue of hot water or hot beverages: Hydrogen gas will be released from water very quickly if boiling the hydrogen-rich water. Because of this, bottled hydrogen-rich water on the market cannot be used for hot coffee or hot tea making. Thin reverse osmosis membrane will break down under the high temperature of boiling water, which will result in releasing of chemical by-products (and metal pieces) into the drinking water and beverages. The “magnesium stick” will have boosted magnesium hydroxide release through its porous case and consequently result in stronger adverse effect if boiling hot water is used. So a method for adding hydrogen gas to hot or boiled water is also needed.

To expand the benefit of hydrogen, there is also an emerging demand to increase the hydrogen content of other hydrogen absorbing materials like fluidic or semi-solid food, cosmetics, skin care and hair care products. The existing methods of magnesium stick and electrolysis cannot work due to the complex and even toxic chemical by-products derived from electrolysis reactions of these materials and those by-products derived from the reactions with metal magnesium.

The current invention is to resolve above discussed issues and to satisfy the above un-met need.

### SUMMARY OF THE INVENTION

This invention discloses the methods and apparatus that can be used to increase the hydrogen concentration in water, in various beverages, and in other hydrogen absorbing materials through a sealed hydrogen gas releasing chamber. The chamber connecting wall is made of materials that have good hydrogen permeability and that can withhold gas pressure differences across the wall. In particular, the materials used for the chamber connecting wall can be rubber, silicone rubber, vinyl methyl silicone rubber, and phenyl vinyl methyl silicone rubber. The gas producing chamber can tolerate the acidic reaction environment, high gas pressure, and hot temperature of the beverages. The hydrogen gas is generated inside the hydrogen gas producing chamber by a hydrogen gas producing system. The hydrogen gas producing system includes a cartridge to dispense hydrogen gas producing chemicals. Example chemicals used inside the cartridge for hydrogen gas generation are magnesium and citric acid. Hydrogen gas is quickly generated, the gas pressure is built up quickly inside the chamber, the hydrogen is released from the chamber into the treated materials through the chamber wall, and the hydrogen concentration in the treated materials increases quickly. At the same time, the connecting wall of the hydrogen gas producing chamber will prevent the leaking of other by-products of the gas producing system into the treated materials. The disclosed methods and apparatus can add hydrogen to water and beverages of wide temperature range from 0 to 100 degree Celsius and beyond, they can add hydrogen to various beverages including soda, energy drink, milk, juice, coffee, and tea etc., they can add hydrogen to various fluidic or semi-solid food, and they can add hydrogen to various lotions and creams used for cosmetics, skin care, and hair care applications.

To this end, in an embodiment of the present invention, an apparatus for adding hydrogen gas into hydrogen absorbing materials is provided. The apparatus comprises: a hydrogen gas producing chamber, wherein the hydrogen gas producing chamber is sealed and is capable of holding an amount of pressurized hydrogen gas therein; and at least one section of the hydrogen gas producing chamber made of a hydrogen permeable material, wherein the at least one section is permeable to hydrogen gas for releasing the hydrogen gas from the chamber into a hydrogen gas absorbing material.

In an embodiment, the hydrogen permeable material is selected from the group consisting of rubber, silicone rubber, vinyl methyl silicone rubber, and phenyl vinyl methyl silicone rubber.

In an embodiment, the apparatus further comprises a hydrogen gas producing cartridge disposed within the hydrogen gas producing chamber, the hydrogen gas producing cartridge comprising hydrogen gas producing chemicals.

In an embodiment, the apparatus further comprises magnesium and citric acid disposed within the hydrogen gas producing chamber for producing hydrogen gas within the hydrogen gas producing chamber.

In an embodiment, the at least one hydrogen absorbing material has a temperature ranging from 0 to 100 degrees Celsius.

In an embodiment, the at least one hydrogen absorbing material is selected from the group consisting of water, beverages, fluidic foods, semi-solid foods, cosmetic liquids, cosmetic creams, and combinations thereof.

In an embodiment, the hydrogen producing chamber is made of the hydrogen permeable material.

In an alternate embodiment of the present invention, a method for adding hydrogen gas into hydrogen absorbing materials is provided. The method comprises the steps of: providing at least one hydrogen absorbing material disposed adjacent the hydrogen gas producing chamber; producing hydrogen gas within the hydrogen producing chamber; and releasing the hydrogen gas through the hydrogen permeable material and into the at least one hydrogen absorbing material.

In an embodiment, the hydrogen gas producing chamber is made of a material selected from the group consisting of rubber, silicone rubber, vinyl methyl silicone rubber, and phenyl vinyl methyl silicone rubber.

In an embodiment, the method further comprises the steps of: disposing a hydrogen gas producing cartridge within the hydrogen gas producing chamber; and reacting at least one hydrogen gas producing chemical in the hydrogen gas producing cartridge.

In an embodiment, the method further comprises mixing magnesium and citric acid within the hydrogen gas producing chamber to form hydrogen gas.

In an embodiment, the method further comprises the step of varying the temperature of the at least one hydrogen absorbing material from 0 to 100 degrees Celsius.

In an embodiment, the at least one hydrogen absorbing material is selected from the group consisting of water, beverages, fluidic foods, semi-solid foods, cosmetic liquids, cosmetic creams, and any combination thereof.

In an embodiment, the hydrogen producing chamber is made of the hydrogen permeable material.

In a further alternate embodiment of the present invention, a cartridge apparatus is provided. The cartridge apparatus comprises: a housing wherein the housing is capable of passing a material through the housing; and at least one chemical capable of producing hydrogen gas.

In an embodiment, the housing is permeable to the material.

In an embodiment, the housing is dissolvable in the material.

In an embodiment, the housing is breakable.

In an embodiment, the hydrogen gas producing chemical is at least one of magnesium and citric acid.

In an embodiment, a method of using the cartridge apparatus is provided. The method comprises the steps of: placing the cartridge apparatus in a receptacle containing the material; exposing the chemical within the cartridge apparatus to the material in the receptacle; forming hydrogen gas when the chemical within the cartridge apparatus is exposed to the material in the receptacle; and releasing the hydrogen gas into the receptacle.

### BRIEF DESCRIPTION OF THE DRAWINGS

FIG. 1. Explanatory cross-section view of a water container with a hydrogen gas producing chamber on the bottom.

FIG. 2. Explanatory cross-section view of a water container with a hydrogen gas producing chamber on the side.

FIG. 3. Explanatory cross-section view of a double layered water container with the space between the two layers as the hydrogen gas producing chamber.

FIG. 4. Explanatory cross-section view of a water container with an inside hydrogen gas producing cartridge.

### DETAILED DESCRIPTION OF THE PRESENTLY PREFERRED EMBODIMENTS

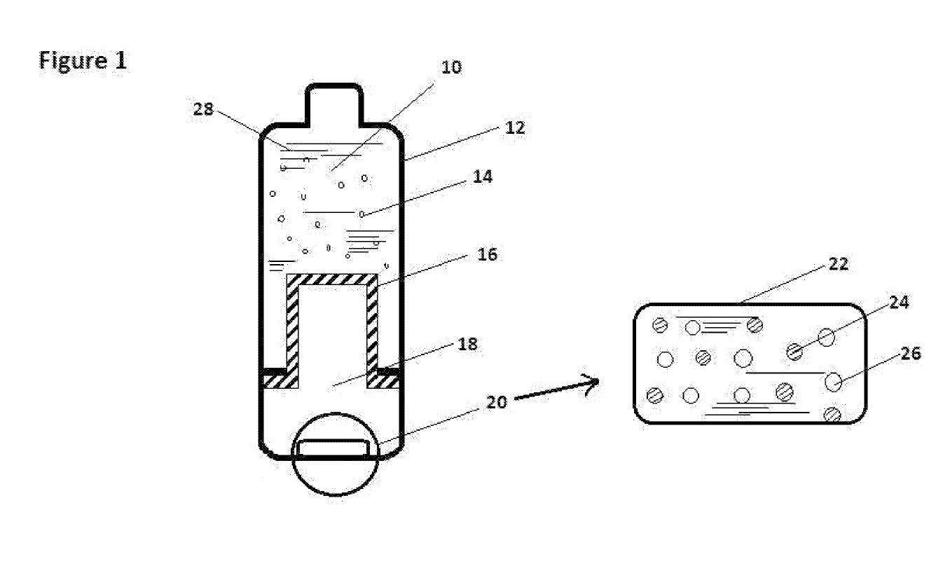

FIG. 1 shows a water container (or other liquid container) with a hydrogen gas producing chamber attached on the bottom. The top compartment 10 may be used for drinking water or beverage or other hydrogen absorbing materials 26 storage. The container wall 12 may be made of many different materials that have poor hydrogen permeability, including various metal, glass, ceramic, plastic etc. The water container may be in many different shapes. The bottom compartment may preferably be the hydrogen gas producing chamber 18. The bottom chamber's connecting wall 16, shared with top compartment 10, may preferably be made of materials that have good hydrogen permeability, and can withhold the gas pressure build-up inside gas producing chamber 18. In particular, the material for 16 may be rubber, silicone rubber, VMQ, or PVMQ. The hydrogen gas producing chamber 18 may be in many different shapes. A cartridge 20 inside the bottom chamber 18 may be used to store and to dispense the reaction chemicals 24, 26 for hydrogen gas 14 generation. Exemplary chemicals include citric acid 26 and magnesium 24, but the invention should not be limited as described herein. The cartridge wall 22 may preferably be water permeable, and the hydrogen gas producing reaction may be initiated by filling some water into the hydrogen gas producing chamber 18.

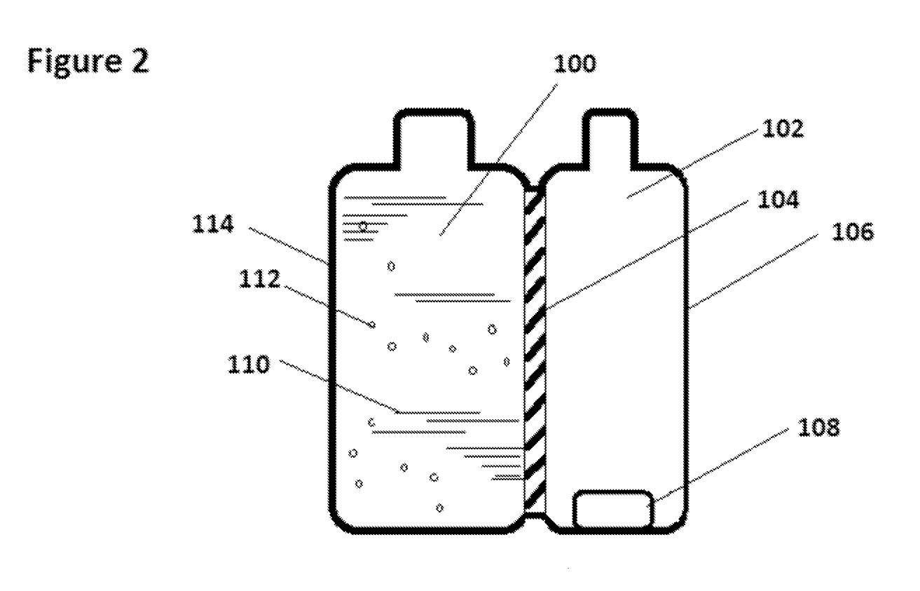

It should be noted that the chemicals utilized within the cartridge 20, contained inside the bottom chamber 18, may be provided in solid and/or liquid form, as apparent to one of ordinary skill in the art. Moreover, instead of mixing the chemicals for causing the product of H₂ within the cartridge 20, the chemicals may be mixed directly within the bottom chamber 20. This aspect of the invention may be applied to all exemplary embodiments contained herein, as disclosed in FIGS. 2-4, below.

Moreover, it may be useful to include a mixer or stirrer within the top compartment 10 for aiding in the dissolution of H₂ gas into the water or other fluid contained therein. The mixer or stirrer (not shown) may allow the container to shake, thereby aiding the dissolution of H₂ gas into the liquid or may consist of a mechanical stifling mechanism, such as a moving paddle, blade, or other like device for stifling the liquid and aiding the dissolution of H₂ gas therein. Again, this aspect of the present invention may further apply to all embodiments described herein, as disclosed in detail in FIGS. 2-4 below.

FIG. 2 shows a water container, or other liquid container, with a hydrogen gas producing chamber attached to the side. The water container is pictured in bottle-shape, but it should be noted that the container may be in many different shapes. The left compartment 100 may preferably be used for drinking water or beverage or other hydrogen absorbing material 110 storage. The container wall 114 may be one or more of many different materials that has poor hydrogen permeability, including various metals, plastic, ceramic, and glass, for example. The right compartment may be the hydrogen gas producing chamber 102. The left compartment's connecting wall 104, shared with the right compartment is made of materials that may have good hydrogen permeability and can withhold the gas pressure build-up inside gas producing chamber 102. In particular, the materials for 104 may be, for example, rubber, silicone rubber, VMQ, PVMQ and other like materials. The rest of the gas producing chamber container wall 106 can be made of many different materials that may have poor hydrogen permeability, including various metal, glass, ceramic, and plastic, for example. A cartridge 108 inside the gas producing chamber 102 may be used to store and to dispense the reaction chemicals for hydrogen gas 112 generation. The chemical examples may preferably be citric acid and magnesium; however, the present invention should not be limited as described herein. The cartridge 108 may preferably be water permeable, and the hydrogen gas producing reaction may be initiated by filling some water into the hydrogen gas producing chamber 102.

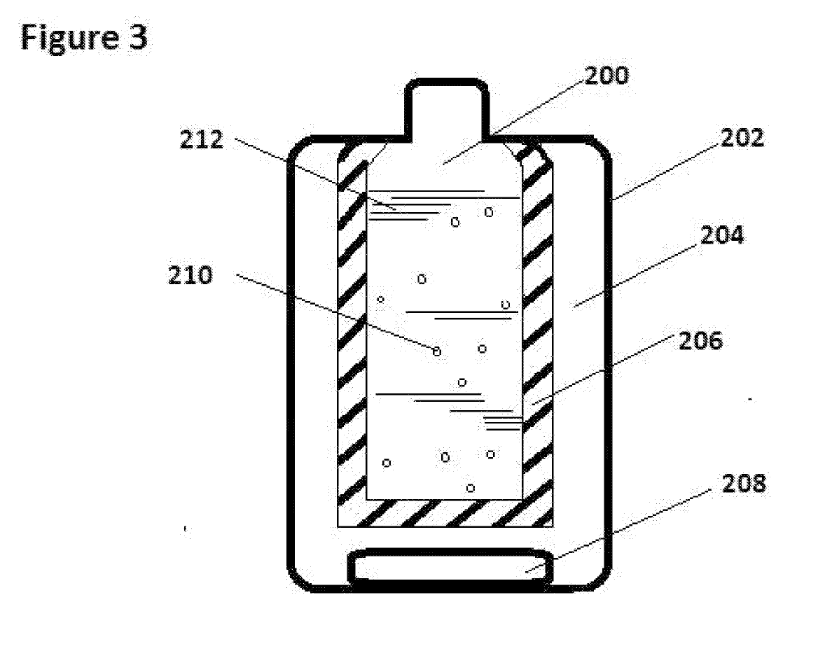

FIG. 3 shows a double-layered water container, or other liquid container, with the space between the two layers as the gas producing chamber. The water container is pictured in bottle-shape, but may be in many different shapes. The inside compartment 200 may be used for drinking water or other beverage or for storage of other hydrogen absorbing materials 212. The external layer 202 may be screwed onto the container to create a space between the two layers. The external layer 202 may be of many different materials that have poor hydrogen permeability, including various metals, plastic, ceramic, and glass, for example. The inner layer 206 of the container is made of materials that may have good hydrogen permeability and can withhold the gas pressure build-up inside gas producing chamber 204. In particular, the materials for inner layer 206 may preferably be rubber, silicone rubber, VMQ, PVMQ, or other like material, and the present invention should not be limited as described herein. The gas producing chamber 204 may preferably be the space between the two layers. A cartridge 208 may be used between the two layers to store and to dispense the reaction chemicals for hydrogen gas 210 generation. The chemical examples may preferably be citric acid and magnesium, but should not be limited as described herein. The cartridge 208 may preferably be water permeable, and the hydrogen gas producing reaction may be initiated by filling some water into the hydrogen gas producing chamber 204.

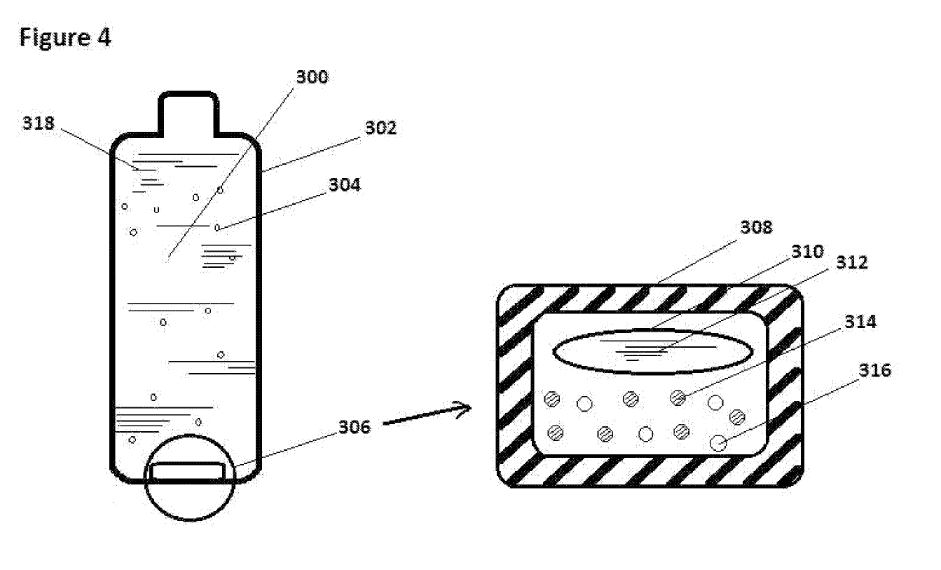

FIG. 4 shows a water container, or other liquid container, with an inside gas producing cartridge. The water container 300 is pictured in bottle-shape, but may be in many different shapes as apparent to one of ordinary skill in the art. The water container may preferably be for water or beverage or other hydrogen absorbing materials 318 storage. The container wall 302 can be of many different materials that may have poor hydrogen permeability, including various metals, glass, ceramic, and plastic, for example. A cartridge 306 may be put directly into the water container 300, and may preferably function as the hydrogen gas producing chamber. The wall of the cartridge 308 may be made of materials that have good hydrogen permeability and can withhold the gas pressure build-up inside the cartridge 306. In particular, the materials for the wall of the cartridge 308 may preferably be rubber, silicone rubber, VMQ, or PVMQ, or any other material having the desired properties described herein and the invention should not be limited as described herein. The cartridge may be composed of solid chemical section for the storage of citric acid 316 and magnesium 314, or other chemicals, and an internal breakable capsule 310 with water 312 inside the capsule. Breaking the capsule by squeezing the cartridge may release the water 312 into the cartridge. The hydrogen gas producing reaction may be initiated after mixing the water released from the capsule 312 with citric acid 316 and magnesium 314. The cartridge may be put into the water container once hydrogen gas producing reaction is initiated, and hydrogen gas 304 may be released into the water or beverages or other hydrogen absorbing materials 318 through the hydrogen gas permeable wall of the cartridge 308.

Besides the design examples demonstrated in FIGS. 1 to 4, some other design examples of the apparatus include, without limitation:

A) A water container, or other liquid container, with the hydrogen gas producing chamber attached on the top. The bottom compartment is used for water and beverage or other hydrogen absorbing materials storage. The top chamber's connecting wall shared with the bottom compartment is made of materials that have good hydrogen permeability and that can withhold gas pressure differences across the connecting wall. In particular, the materials used may preferably be rubber, silicone rubber, VMQ, or PVMQ, or other material as described herein. A cartridge inside the hydrogen gas producing chamber is used to store and to dispense the reaction chemicals for hydrogen gas generation.

B) A water container, or other liquid container, with a hydrogen gas producing chamber floating inside the water container. The floating chamber's wall may be made of materials that have good hydrogen permeability and that can withhold gas pressure differences across the wall. In particular, the materials used to make the chamber's wall may preferably be rubber, silicone rubber, VMQ, or PVMQ, or other like material as described herein. A cartridge inside the floating chamber may be used to store and to dispense the reaction chemicals for hydrogen gas generation.

The apparatus designs are not limited to these examples shown in the disclosure. Other variations of the apparatus design can be implemented readily to those who are skilled in the art, especially by practicing the disclosed method.

The hydrogen gas permeability (P) is described as:

P=(v·δ)/(A·t·(P1−P0))=mol H₂/m·S·MPa (I)

where v is the volume of gas that passed through the connecting wall 16, which may be measured as “mol” of hydrogen; δ is the thickness of the connecting wall, which may be measured as “meter”; A is the exposed area for hydrogen gas interface (measured as square meter); t is the time length, and is measured as “second”; and P1 and P0 are the hydrogen gas pressures at the two sides of the connecting wall, and may be measured as “MPa”. The unit of permeability is “mol H₂/m·s·MPa”. Permeability may also be influenced by the environment temperature (for example, the higher the temperature, the greater the permeability). Materials with good hydrogen permeability as disclosed in this invention may be defined as materials with hydrogen permeability greater than about 1×10⁻⁹ mol H₂/m·s·MPa at room temperature; preferably, greater than about 5×10⁹ mol H₂/m·s·MPa; more preferably greater than about 10×10⁻⁹ mol H₂/m·s·MPa and most preferably greater than about 20×10⁻⁹ mol H₂/m·s·MPa.

Rubber is used herein as an exemplary material for connecting wall (16 of FIG. 1, 104 of FIG. 2, 206 of FIG. 3, and the wall of cartridge 308 in FIG. 4) to allow hydrogen gas releasing into the treated water, beverages or other hydrogen absorbing materials. Rubber may have a wide hydrogen gas permeability ranging from 1×10⁻⁹ to 1×10⁻⁷ mol H₂/m·s·MPa at room temperature. However, rubber is typically used for “air-tight” sealing of a container to prevent the liquid or gas leaking (not releasing). To use rubber as an effective and quick hydrogen gas “releasing” interface, as described herein in the present invention, is very novel and against the common wisdom. Through engineering, the efficiency of hydrogen transfer across the rubber wall can be further improved by: 1) making the rubber wall thinner while maintaining its physical durability; and/or 2) using specific types of rubber or specific compositions of rubber to further boost permeability. For example, silicone rubber, in particular, vinyl methyl silicone rubber (VMQ) and phenyl vinyl methyl silicones rubber (PVMQ) has even better permeability compared to many other types of rubber. Rubber typically has low permeability to water and ions, and rubber is typically not an osmosis membrane. Hydrogen gas transfer efficiency across the rubber wall may be directly related to the hydrogen gas pressure differences between the two sides of the rubber wall. To ensure quick release of the hydrogen gas, it is critical to seal the chamber tightly to build up the gas pressure inside the chamber. To ensure proper physical durability of the rubber wall to bear the high pressured chamber while maintaining its good permeability, proper thickness of the rubber wall is important. The typical thickness of a rubber wall may be no less than about 0.1 mm. The gas pressure inside the gas producing chamber may preferably be higher than 1 bar. Preferably, gas pressure inside the gas producing chamber may ranted from about 1 bar to about 3 bars, but it not limited as described herein. The higher the gas pressure is, the quicker the hydrogen release is. As demonstrated in our examples, the rubber wall can be engineered as a quick and effective interface for hydrogen gas releasing into the water and into other materials.

Rubber represents a big polymer family with permeability of hydrogen and good physical durability. Among them, silicone rubber, in particular, vinyl methyl silicone rubber (VMQ) and phenyl vinyl methyl silicone rubber (PVMQ), have good hydrogen gas permeability, and non-reactive to acid or alkaline, very stable, and resistant to temperatures from −55° C. to +300° C. while still maintaining its useful properties. Silicone rubber is safe to use with food or drink.

The disclosed invention is not limited to rubber (nor silicone rubber, or VMQ or PVMQ) as the connecting wall for the hydrogen gas producing chamber. Many other materials, particularly polymers, which have good hydrogen permeability and can withhold gas pressure, and can be used to make the connecting wall (16 of FIG. 1, 104 of FIG. 2, 206 of FIG. 3, and the wall of cartridge 308 in FIG. 4) for hydrogen gas producing chamber.

To ensure convenience for daily usage of the disclosed apparatus, the chemicals used for producing hydrogen gas should be pre-weighted and packaged in a cartridge (20 in FIG. 1, 108 in FIG. 2, 208 in FIGS. 3, and 306 in FIG. 4). Cartridge in this invention is defined as an apparatus to store at least one of the reagents required for the hydrogen gas generation. The cartridge examples include:

A) Bag Cartridge. The hydrogen gas producing solid reagents (for example, citric acid 26 of FIG. 1 and magnesium 24 of FIG. 1) are sealed inside a water permeable bag. Water can get into the cartridge bag to initiate the hydrogen gas producing reaction.

B) Quick dissolving cartridge. The hydrogen gas producing solid reagents (for example citric acid and magnesium) is formulated as a pill, which can be dissolved quickly in water.

C) Porous polymer cartridge. Cartridge wall made of porous plastic or other types of porous polymers. The hydrogen gas producing solid chemicals (for example, citric acid 26 of FIG. 1 and magnesium 24 of FIG. 1) are sealed inside the porous polymer cartridge. Water can get into the cartridge through the porous wall to initiate the hydrogen gas producing reaction.

D) Cartridge directly used as the gas producing chamber as demonstrated in FIG. 4. The cartridge wall is non-porous and air-tight sealed. The cartridge wall is made of material that is permeable of hydrogen and can withhold the pressure of gas build-up inside the cartridge. In particular, the cartridge wall is made of rubber, silicon rubber, VMQ, or PVMQ. The cartridge is composed of solid chemical storage section (for example, storing citric acid and magnesium), and an internal breakable capsule with liquid (for example, water) inside the capsule. Breaking the capsule by squeezing the cartridge will release the water to trigger the hydrogen gas producing chemical reaction.

Besides the four examples of cartridge design disclosed above, other variations of the cartridge design can be implemented readily to those who are skilled in the art, especially by practicing the disclosed method.

The chemical reaction example for quick hydrogen gas production disclosed in this invention is between magnesium metal (24 in FIG. 1, 314 in FIG. 4) and citric acid (26 in FIG. 1, 316 in FIG. 4).

Mg+Citric Acid=Magnesium Citrate+H₂ (II)

The above reaction can produce hydrogen gas very quickly, and its gas generating speed is multiple magnitudes faster compared to the slow reaction between magnesium and water (used by “magnesium stick” method).

Many different kinds of acids (e.g. hydrochloride, lactic) can react with magnesium to produce hydrogen gas quickly. There are also many fast methods for hydrogen gas production without using acid, for example, the reaction between magnesium hydride and water (MgH₂+2H₂0=Mg(OH)₂+2H₂). The nano-particle of magnesium reacting with water can be used to produce hydrogen gas very quickly as well. Chemical reaction used for quick hydrogen gas generation also includes the electro-chemical reaction, such as water electrolysis. Pre-made high pressured hydrogen gas can also be directly stored in the hydrogen releasing chamber. The hydrogen gas producing system to be protected here is not limited to the magnesium and citric acid reaction.

The apparatus disclosed here can be used for adding hydrogen not only into regular room temperature drinking water, and it can also add hydrogen into: 1) Hot and boiling water and beverages (e.g. coffee or tea etc.); 2) All different kinds of popular beverages (e.g. juice, milk, soda, energy drink etc.); 3) Fluidic or semi-solid food (e.g. Yogurt); and 4) Semi-solid cream or lotion used for cosmetics, skin care, hair care applications. The beverages, food, semi-solid creams listed here are just examples of hydrogen absorbing materials, and this invention is not limited to adding hydrogen into these examples. As demonstrated in the example session, the invented methods and apparatus can be used to add hydrogen into water, beverages, and semi-solid products quickly without any difficulty while preventing the leakage of other undesired chemicals into the treated products.

The following examples are merely illustrative of this disclosed invention, are not intended to be limitative in any way:

### Detailed Examples

A bag cartridge 20 is used to store and to dispense the reaction chemicals, which are compose of 0.54 g of solid food-grade citric acid 26 of 100% pure and 0.12 g of magnesium metal 24 of 99.9% pure. Put the cartridge 20 into the gas producing chamber 18 as demonstrated in FIG. 1. The connecting wall 16 of the gas producing chamber is made of vinyl methyl silicone rubber. The thickness of the connecting wall 16 is 1 mm. 20 ml of filtered water is put into the gas producing chamber 18 to dissolve the citric acid 26 and to initiate the reaction between citric acid 26 and magnesium 24. The gas producing chamber 18 is sealed using a screwed cap, which allows the build-up of gas pressure in the gas producing chamber 18.

### Experiment 1

### Experiment on Adding Hydrogen into Drinking Water

Once the gas producing chamber is securely closed, fill the water storage compartment 10 with 400 ml of filtered drinking water 28. Many small air bubbles start to appear immediately all over the surface of connecting wall 16 of the gas producing chamber 18. Oxidation and reduction potential (ORP) value is measured to estimate the level of the dissolved hydrogen gas into the water. In one hour, the ORP value is dropped to below −250. Total dissolved salt (TDS) is measured to evaluate whether there is magnesium or other ion leakage into the drinking water. The TDS value is unchanged, for a particular example, the TDS value is maintained at 108 ppm during 24 hours of testing. As a comparison, the TDS level inside the gas producing chamber 18 typically reached to the level of 1200 ppm. The pH value of the drinking water 28 is also measured. There is slightly pH value increase in the range of 0.2-0.4 point, which is associated with the dissolving of the hydrogen gas. As a comparison, the pH value inside the gas producing chamber 18 is dropped to the level of pH 3, and then gradually increases to the level of pH 5.

As a comparison to “magnesium stick” product on the market, the ORP value of “magnesium stick” treated water can only reach −50 after 24 hours of treatment. The relationship between ORP and hydrogen concentration is logarithm relationship. Based on this data, the estimated speed of adding hydrogen into water of the current disclosed apparatus is 50 to 85 folds faster than that of the “magnesium stick” product on the market.

### Experiment 2

### Experiment on Adding Hydrogen into Hot Tea

Once the gas producing chamber 18 is securely closed, fill the water storage compartment 10 with 400 ml of freshly brewed tea (Lipton green tea) 28 with a temperature of 97 degree Celsius. Many small air bubbles start to appear immediately all over the surface of the connecting wall 16 of the gas producing chamber 18. ORP value is measured to estimate the level of the dissolved hydrogen gas into the water. In half an hour, the ORP value of the tea is dropped to below −250. TDS is measured to evaluate whether there is magnesium or other ion leakage into the tea 28. The TDS value of the tea is unchanged, for a particular example, the TDS value is maintained at 173 ppm during 24 hours of testing. As a control, the ORP value of the un-treated tea (not adding hydrogen) is maintained at around +28 for the first two hours, and then the ORP values gradually increase to +49 in 24 hours. As a comparison, “magnesium stick” method cannot be used for hot tea.

### Experiment 3

### Experiment on Adding Hydrogen into Hot Coffee

Once the hydrogen gas producing chamber 18 is securely closed, fill the water storage compartment 10 with 400 ml of freshly brewed coffee (Tongkat Ali) 28 with a temperature of 100 degree Celsius. ORP value is measured to estimate the level of the dissolved hydrogen gas into the water. In half an hour, the ORP value of the coffee is dropped to below −250. TDS is measured to evaluate whether there is magnesium or other ion leakage into the coffee 28. The TDS value of the coffee is unchanged, for a particular example, the TDS value is maintained at 603 ppm during 24 hours of testing. As a control, the ORP value of the un-treated coffee (not adding hydrogen) is maintained at around +35 for the first two hours, and then the ORP values gradually increase to +72 in 24 hours. As a comparison, “magnesium stick” method cannot be used for hot coffee.

### Experiment 4

### Experiment on Adding Hydrogen into Orange Juice

Once the hydrogen gas producing chamber 18 is securely closed, fill the water storage compartment 10 with 400 ml of orange juice (Minute Maid Premium) 28 with a temperature of 4 degree Celsius. ORP value is measured to estimate the level of the dissolved hydrogen gas into the juice. In one hour, the ORP value of the juice is dropped below −250. TDS is measured to evaluate whether there is magnesium or other ion leakage into the juice. The TDS value of the orange juice 26 is unchanged, for a particular example, the TDS value is maintained at 2320 ppm during 24 hours of testing. As a control, the ORP value of the un-treated juice (not adding hydrogen) is maintained at around +80. As a comparison, “magnesium stick” method cannot be used for orange juice.

### Experiment 5

### Experiment on Adding Hydrogen into Milk

Once the hydrogen gas producing chamber 18 is securely closed, fill the water storage compartment 10 with 400 ml of milk (2% fat) 28 with a temperature of 4 degree Celsius (and also maintained at 4 degree Celsius during the treatment period). ORP value is measured to estimate the level of the dissolved hydrogen gas into the milk. In one hour, the ORP value of the milk 28 is dropped below −250. TDS is measured to evaluate whether there is magnesium or other ion leakage into the milk. The TDS value is unchanged, for a particular example, the TDS value of the milk is maintained at 2370 ppm during 24 hours of testing. As a control, the ORP value of the un-treated milk (not adding hydrogen) is maintained at around +94. As a comparison, “magnesium stick” method cannot be used for milk.

### Experiment 6

### Experiment on Adding Hydrogen into Soda (Sprite)

Once the hydrogen gas producing chamber 18 is securely closed, fill the water storage compartment 10 with 400 ml of Sprite soda 28. ORP value is measured to estimate the level of the dissolved hydrogen gas into the soda. In one hour, the ORP value of the soda is dropped below −250. TDS is measured to evaluate whether there is magnesium or other ion leakage into the soda 28. The TDS value of the soda 28 is unchanged, for a particular example, the TDS value is maintained at 198 ppm during 24 hours of testing. As a control, the ORP value of the un-treated soda (not adding hydrogen) is maintained at around +357. As a comparison, “magnesium stick” method cannot be used for soda.

### Experiment 7

### Experiment on Adding Hydrogen into Energy Drink (Gatorade G Series)

Once the hydrogen gas producing chamber 18 is securely closed, fill the top water storage compartment 10 with 400 ml of Gatorade drink 28. ORP value is measured to estimate the level of the dissolved hydrogen gas into the drink. In one hour, the ORP value of the drink is dropped below −250. TDS is measured to evaluate whether there is magnesium or other ion leakage into the drink 28. The TDS value is unchanged, for a particular example, the TDS value is maintained at 1010 ppm during 24 hours of testing. As a control, the ORP value of the un-treated drink (not adding hydrogen) is maintained at around +437. As a comparison, “magnesium stick” method cannot be used for an energy drink.

### Experiment 8

### Experiment on Adding Hydrogen into Yogurt (Chobani)

Once the hydrogen gas producing chamber 18 is securely closed, fill the top compartment 10 with 100 g of Yogurt 28 with a temperature of 4 degrees Celsius. The treatment is carried out at 4 degree Celsius. ORP value is measured to estimate the level of the dissolved hydrogen gas into the Yogurt. In six hours, the ORP value of the Yogurt 28 is dropped below −250. As a control, the ORP value of the un-treated Yogurt (not adding hydrogen) is maintained at around +283. There is no difference on pH value between treated and untreated Yogurt. As a comparison, “magnesium stick” method cannot be used for Yogurt.

### Experiment 9

### Experiment on Adding Hydrogen into a Skincare Lotion (Nivea Moisturizing Fresh Lotion)

Once the hydrogen gas producing chamber 18 is securely closed, fill the top compartment 10 with 100 g of lotion 28. ORP value is measured to estimate the level of the dissolved hydrogen gas into the lotion. In six hours, the ORP value of the lotion 28 is dropped below −250. As a control, the ORP value of the un-treated lotion (not adding hydrogen) is maintained at around +322. As a comparison, “magnesium stick” method cannot be used for skincare lotion.

### REFERENCES

U.S. Pat. No. 7,189,330. Hayashi, et al. Mar. 13, 2007
U.S. Pat. No. 7,560,091. Hayashi, etc. Jul. 14, 2009
United States Patent Application US20080311225. Seiki Shiga. Dec. 18, 2008
Atsunori Nakao, Yoshiya Toyodal, Prachi Sharma, Malkanthi Evans and Najla Guthrie. Effectiveness of hydrogen-rich water on antioxidant status of subjects with potential metabolic syndrome—an open label pilot study. J. Clin. Biochem. Nutr., 46, 140-149, March 2010
United States Patent Application US20100008850. William John Martin. Jul. 14, 2008
United States Patent Application US20100008849. William John Martin. Jul. 14, 2008

We claim:

1. An apparatus for adding hydrogen gas into hydrogen absorbing materials, the apparatus comprising:
a hydrogen gas producing chamber, wherein the hydrogen gas producing chamber is sealed and is capable of holding an amount of pressurized hydrogen gas therein; and
at least one section of the hydrogen gas producing chamber made of a hydrogen permeable material, wherein the at least one section is permeable to hydrogen gas for releasing the hydrogen gas from the chamber into a hydrogen gas absorbing material.

2. The apparatus of claim 1 wherein the hydrogen permeable material is selected from the group consisting of rubber, silicone rubber, vinyl methyl silicone rubber, and phenyl vinyl methyl silicone rubber.

3. The apparatus of claim 1 further comprising:
a hydrogen gas producing cartridge disposed within the hydrogen gas producing chamber, the hydrogen gas producing cartridge comprising hydrogen gas producing chemicals.

4. The apparatus of claim 1 further comprising:
magnesium and citric acid disposed within the hydrogen gas producing chamber for producing hydrogen gas within the hydrogen gas producing chamber.

5. The apparatus of claim 1 wherein the at least one hydrogen absorbing material has a temperature ranging from 0 to 100 degrees Celsius.

6. The apparatus of claim 1 wherein the at least one hydrogen absorbing material is selected from the group consisting of water, beverages, fluidic foods, semi-solid foods, cosmetic liquids, cosmetic creams, and combinations thereof.

7. The apparatus of claim 1 wherein the hydrogen producing chamber is made of the hydrogen permeable material.

8. A method for adding hydrogen gas into hydrogen absorbing materials using the apparatus of claim 1, the method comprising the steps of:
providing at least one hydrogen absorbing material disposed adjacent the hydrogen gas producing chamber;
producing hydrogen gas within the hydrogen producing chamber; and
releasing the hydrogen gas through the hydrogen permeable material and into the at least one hydrogen absorbing material.

9. The method of claim 8 wherein the hydrogen gas producing chamber is made of a material selected from the group consisting of rubber, silicone rubber, vinyl methyl silicone rubber, and phenyl vinyl methyl silicone rubber.

10. The method of claim 8 further comprising the steps of:
disposing a hydrogen gas producing cartridge within the hydrogen gas producing chamber; and
reacting at least one hydrogen gas producing chemical in the hydrogen gas producing cartridge.

11. The method of claim 8 further comprising the step of:
mixing magnesium and citric acid within the hydrogen gas producing chamber to form hydrogen gas.

12. The method of claim 8 further comprising the step of:
varying the temperature of the at least one hydrogen absorbing material from 0 to 100 degrees Celsius.

13. The method of claim 8 wherein the at least one hydrogen absorbing material is selected from the group consisting of water, beverages, fluidic foods, semi-solid foods, cosmetic liquids, cosmetic creams, and any combination thereof.

14. The method of claim 8 wherein the hydrogen producing chamber is made of the hydrogen permeable material.

15. A cartridge apparatus comprising:
a housing wherein the housing is capable of passing a material through the housing; and
at least one chemical capable of producing hydrogen gas.

16. The cartridge apparatus of claim 15 wherein the housing is permeable to the material.

17. The cartridge apparatus of claim 15 wherein the housing is dissolvable in the material.

18. The cartridge apparatus of claim 15 wherein the housing is breakable.

19. The cartridge apparatus of claim 15 wherein the hydrogen gas producing chemical is at least one of magnesium and citric acid.

20. A method of using the cartridge apparatus of claim 15, comprising the steps of:
placing the cartridge apparatus in a receptacle containing the material;
exposing the chemical within the cartridge apparatus to the material in the receptacle;
forming hydrogen gas when the chemical within the cartridge apparatus is exposed to the material in the receptacle; and
releasing the hydrogen gas into the receptacle.
